(19) United States
(12) Patent Application Publication
(10) Pub. No.: US 2009/0168174 A1
(43) Pub. Date: Jul. 2, 2009

(54) Structure of Stereo Optical Engine for Projection

(75) Inventors: Jung Hoi Kim, Gwangju (KR); Hoi Jin Ha, Seoul (KR)

Correspondence Address: THE NATH LAW GROUP, 112 South West Street, Alexandria, VA, 22314, US

(73) Assignee: REDROVER CO., LTD., Seongnam-city (KR)

(21) Appl. No.: 12/227,866

(22) PCT Filed: May 29, 2007
(86) PCT No.: PCT/KR2007/002607

§ 371 Date: Dec. 1, 2008

(30) Foreign Application Priority Data
May 29, 2006 (KR) 10-2006-0048053

(51) Int. Cl. G02B 27/18; G02B 27/26

(52) U.S. Cl. 359/495

(57) ABSTRACT

The present invention relates to a stereo optical engine structure for projection, and more particularly, to a stereo optical engine structure for projection for combining two images to project one stereo image. The present invention discloses a stereo optical engine structure for projection, comprising: a first polarization beam splitter 11 for allowing a horizontally polarized light beam to be transmitted thereto and a vertically polarized light beam to be reflected therefrom among light beams emitted from light sources; color wheels 17,19 for correcting and combining the respective colors of the horizontally polarized light beam and the vertically polarized light beam which are separated from the first polarization beam splitter 11; left and right DLPs 21,23 for receiving the horizontally polarized light beam 13 and the vertically polarized light beam 15 which have passed through the color wheels 17,19, respectively, from the first polarization beam splitter 11 and projecting a horizontally polarized image and a vertically polarized image therefrom; a second polarization beam splitter 29 for combining the horizontally polarized image 25 and the vertically polarized image 27 projected from the left and right DLPs 21,23, respectively, into one stereo image; and a lens 31 for allowing the stereo image combined by the second polarization beam splitter to be projected to a stereo screen therethrough.

### TECHNICAL FIELD

The present invention relates to a stereo optical engine structure for projection, and more particularly, to a stereo optical engine structure for projection for combining two images to project one stereo image.

### BACKGROUND ART

In general, in order to view stereo images, a variety of image formers are used. In an existing projection stereo image combiner, one projector is used to project an image. A viewer who wears a shutter glass views the image projected from the projector, so that he or she can view a consecutive and stereo image.

However, the method of projecting an image by using one projector and combining the image in a three-dimensional manner by using the shutter glass is advantageous in that an apparatus thereof is cheap, a construction is simple, and a weight is light, but is problematic in that it is not practical in various aspects.

For example, in order for an image projected from one projector to be recognized as a stereo image, a viewer has to wear the shutter glass so as to view the image. At this time, the shutter provided in the shutter glass must be operated to open or close at a rate of 24 times per second or more. As a result, a device for driving the shutter becomes heavy. Thus, it is difficult to use the shutter glass equipped with this heavy shutter for a long time, and a severe flicking phenomenon occurs due to the operation of the shutter, thereby causing vertigo.

Meanwhile, as another conventional stereo image combination method, there is a typical method of producing a stereo image by using two projectors. That is, two projectors are used, and a 45-degree (or 90-degree) polarization filter is disposed at the front of a lens of one of the two projectors and a 135-degree (0-degree) polarization filter is disposed at the front of a lens of the other of the two projectors. Left and right images are projected to the respective projectors. At this time, a screen employs a silver screen. A viewer sees the images with glasses put on.

However, in this conventional stereo image combination method, the price is high because two projectors are used. There was a problem in that the volume is increased since two projectors must be stacked leftwardly and rightwardly or upwardly and downwardly.

In particular, the above conventional apparatus was disadvantageous in that a setting task for accurately focusing an image must be performed individually according to the situation of a place in case where the apparatus is temporarily installed at a place requiring projection, and was problematic in that alignment is easily twisted due to external shock.

Further, two optical axes exist since two projectors are stacked leftwardly and rightwardly or upwardly and downwardly. In this case, the two projectors can be aligned easily only when a projector having a lens shift function (of moving an image by moving the lens up and down/left and right) is used to combine the two optical axes into one. However, there was a problem in that alignment must be performed again by employing lens shift if a projection length increases or decreases even though alignment is completed.

Furthermore, a linear polarization filter has light transmittance of about 30 to 40%, and allows only 30 to 40% of a total of beam luminance, emitted from one projector, to transmit therethrough. Accordingly, there was a problem in that the linear polarization filter has great loss of light transmittance.

### DISCLOSURE OF INVENTION

### Technical Problem

Accordingly, the present invention has been made in an effort to solve the above problems occurring in the above conventional stereo image combiner, and an object of the present invention is to provide a stereo optical engine structure for projection, in which setting is very simple, and an image can be adjusted simply, if necessary.

### Technical Solution

To achieve the above object, according to the present invention, there is provided a stereo optical engine structure for projection, comprising: a first polarization beam splitter 11 for allowing a horizontally polarized light beam to be transmitted thereto and a vertically polarized light beam to be reflected therefrom among light beams emitted from light sources; color wheels 17,19 for correcting and combining the respective colors of the horizontally polarized light beam and the vertically polarized light beam which are separated from the first polarization beam splitter 11; left and right DLPs 21,23 for receiving the horizontally polarized light beam 13 and the vertically polarized light beam 15 which have passed through the color wheels 17,19, respectively, from the first polarization beam splitter 11 and projecting a horizontally polarized image and a vertically polarized image therefrom; a second polarization beam splitter 29 for combining the horizontally polarized image 25 and the vertically polarized image 27 projected from the left and right DLPs 21,23, respectively, into one stereo image; and a lens 31 for allowing the stereo image combined by the second polarization beam splitter 29 to be projected to a stereo screen therethrough.

In the present invention, two light beams emitted from two light sources are collected into one light beam through a prism. The collected light beam through the prism is reflected from a mirror and then bisected at a first polarization beam splitter. A half light beam is reflected and has its direction shifted, and the remaining half light beam is transmitted and split into left and right light beams. The left and right light beams, which have been split at the first polarization beam splitter, are sent to left and right DLPs, respectively, through color wheels for correcting and combining colors, and then projected from the left and right DLPs, respectively. The left and right light beams projected from the left and right DLPs are combined into one stereo image at a second polarization beam splitter and then projected to a stereo screen through a lens, so that a stereo image can be represented.

The optical engine structure constructed above according to the present invention can be used for use in either a high luminance or a low luminance by turning on both or one of the two light sources according to a use condition. Since two polarization beam splitters and two DLPs are used, an optical axis is shared. Thus, the optical engine structure of the present invention can be easily installed by controlling only focusing without regard to a field condition.

### ADVANTAGEOUS EFFECTS

In accordance with the stereo optical engine according to the present invention, a light beam emitted from light sources 1,3 has its direction shifted through a prism 5, a mirror 9, a first polarization beam splitter 11, DLPs 21, 23, and a second polarization beam splitter 29, and is then generated as one stereo image. Accordingly, there are advantages in that accurate and clear images can be obtained by controlling a setting state simply, if necessary, and a projection stereo image combiner can be implemented cheaply compared with a case where two projectors are moved.

Further, in the present invention, images combined by the second polarization beam splitter 29 have the same optical axes, and only one projection lens is used. Accordingly, there are advantages in that additional alignment is not required, and alignment of an optical axis depending on a projection length is unnecessary.

In addition, there are advantages in that zoom magnification or focusing between two lenses needs not to be set identically since zoom or focusing is performed by one lens, and cost, volume and/or weight can be decreased since the entire optical system is integrated into one without using two optical systems as in the prior art.

### BRIEF DESCRIPTION OF THE DRAWINGS

FIG. 1 is a conceptual view illustrating a stereo optical engine structure for projection according to the present invention.

### DESCRIPTION ON REFERENCE NUMERALS

1,3: light source
5: prism
7: collected light beam
9: mirror
11: first polarization beam splitter
13: horizontally polarized light beam
15: vertically polarized light beam
17, 19: color wheel
21, 23: DLP
25: horizontally polarized image
27: vertically polarized image
29: second polarization beam splitter
31: lens
33: stereo screen

### MODE FOR THE INVENTION

The present invention will now be described in detail with reference to the accompanying drawings.

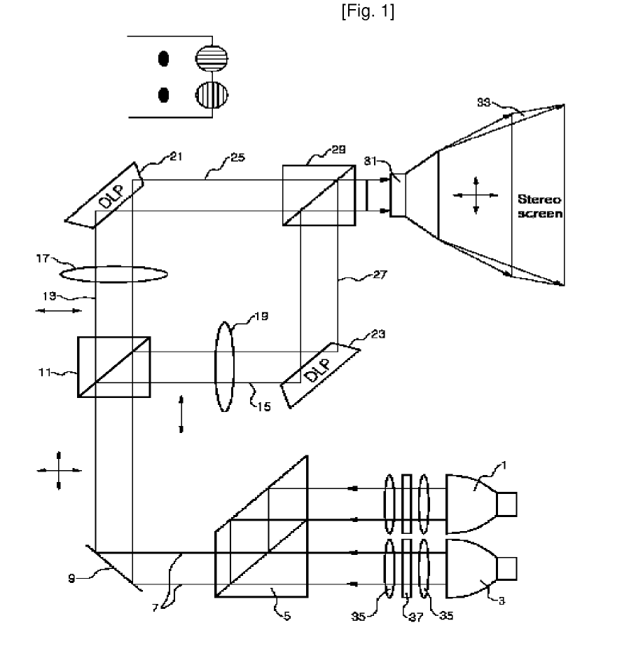

FIG. 1 is a conceptual view illustrating a stereo optical engine structure for projection according to the present invention. As shown in the drawing, in the stereo optical engine structure according to the present invention, two light beams emitted from two light sources 1,3 are gathered into one light beam 7 through a prism 5. The collected light beam 7, which has passed through the prism 5, is reflected from a mirror 9 and then bisected at a first polarization beam splitter 11. A light beam 13 whose polarization direction is horizontal is transmitted, and a light beam 15 whose polarization direction is vertical is reflected and has its direction shifted. The horizontally and vertically polarized light beams 13,15, which are separated from the first polarization beam splitter 11, are transferred to left and right DLPs 21,23, respectively, through color wheels 17,19 for correcting and combining colors, and are then projected from the left and right DLPs 21,23. The horizontally polarized image 25 and the vertically polarized image 27 projected from the left and right DLPs 21,23 are combined into one stereo image at a second polarization beam splitter 29, and then projected on a stereo screen 33 through a lens 31, so that a stereo image can be represented.

The light sources 1,3 can generally include lamps, etc. Known lamps may be properly selected and used.

Further, the light sources 1,3 are basically adapted to provide light to an image projected from a DLP, and one of or both the light sources 1,3 may be used, if necessary. For example, for the purpose of public relations or presentation, the two light sources may be used in order to obtain high luminance. For the purpose of personal cinema appreciation, only one light source can be used to project a light beam of low luminance.

Meanwhile, the light beams emitted from the light sources 1,3 can be controlled through several lenses 35 and filters 37 in order to obtain uniform beam distributions.

The light beams emitted from the light sources 1,3 are gathered into one light beam 7 at the prism 5, and then transferred to the mirror 9.

Thus, in the present invention, in order to obtain an accurate stereo image, the slope angle of the mirror 1 can be primarily changed to control the setting state.

Thereafter, the light beam reflected from the mirror 9 is separated into the horizontally polarized light beam 13 and the vertically polarized light beam 15 by the first polarization beam splitter 11 of the present invention. The horizontally polarized light beam 13 transmits the first polarization beam splitter 11 and travels straight, and the vertically polarized light beam 15 is reflected from the first polarization beam splitter 11 and has its direction shifted.

The horizontally polarized light beam 13 and the vertically polarized light beam 15 have their colors properly combined through the respective color wheels 17,19 according to the colors of the light sources 1,3, so that color images can be obtained.

The horizontally polarized light beam 13 and the vertically polarized light beam 15 whose colors have been combined through the color wheels 17,19 are emitted on the left and right DLPs 21,23. The light beams are irradiated on images, represented at the DLPs 21,23, to produce one image. At this time, the images produced from the left and right DLPs 21,23 result from the horizontally polarized light beam 13 and the vertically polarized light beam 15, and are therefore divided into the horizontally polarized image 25 and the vertically polarized image 27.

The horizontally and vertically polarized images 25,27 are combined at the second polarization beam splitter 29. The process of combining the images at the second polarization beam splitter 29 is the inverse process of separating the image at the first polarization beam splitter 11 according to the vertical and horizontal polarization directions.

The images combined at the second polarization beam splitter 29 include the images 25,27 of the vertical and horizontal directions and are then represented as a stereo image. The stereo image combined at the second polarization beam splitter 29 is transferred to the stereo screen 33 through the lens 31, so that a complete stereo image can be represented.

As described above, in the apparatus according to the present invention, light beams emitted from the light sources 1,3 have their directions shifted through the prism 5, the mirror 9, the first polarization beam splitter 11, the DLPs 21,23, and the second polarization beam splitter 29, producing a pair of stereo images to share one optical axis. Thus, in the engine structure of the present invention, an optical axis is shared and, therefore, only focusing can be controlled, unlike an existing two-projector system in which alignment must be performed by employing a function, such as lens shift or keyston, in case where zoom magnification or distance varies according to environment.

### INDUSTRIAL APPLICABILITY

The present invention can be applied to a variety of stereo image output devices, in particular, various projector devices for projecting stereo images to a screen.

1. A stereo optical engine structure for projection, comprising:
a first polarization beam splitter 11 for allowing a horizontally polarized light beam to be transmitted thereto and a vertically polarized light beam to be reflected therefrom among light beams emitted from light sources;
color wheels 17,19 for correcting and combining the respective colors of the horizontally polarized light beam and the vertically polarized light beam which are separated from the first polarization beam splitter 11;
left and right DLPs 21,23 for receiving the horizontally polarized light beam 13 and the vertically polarized light beam 15 which have passed through the color wheels 17,19, respectively, from the first polarization beam splitter 11 and projecting a horizontally polarized image and a vertically polarized image therefrom;
a second polarization beam splitter 29 for combining the horizontally polarized image 25 and the vertically polarized image 27 projected from the left and right DLPs 21,23, respectively, into one stereo image; and
a lens 31 for allowing the stereo image combined by the second polarization beam splitter 29 to be projected to a stereo screen therethrough.

2. The stereo optical engine structure for projection according to claim 1, wherein a light beam incident to the first polarization beam splitter 11 is a collected light beam 7 formed by collecting two light beams emitted from two light sources 1,3 into one light beam through a prism 5.

3. The stereo optical engine structure for projection according to claim 1, wherein each of the two light sources 1,3 can be turned ON/OFF.
